(19) United States
(12) Patent Application Publication
(10) Pub. No.: US 2024/0023207 A1
(43) Pub. Date: Jan. 18, 2024

(54) A HEATING ELEMENT COMPRISING A CONDUCTIVE MESH

(71) Applicant: Philip Morris Products S.A., Neuchatel (CH)

(72) Inventors: Guillaume FREDERICK, Neuchatel (CH); Ihar Nikolaevich ZINOVIK (Deceased), (US)

(73) Assignee: Philip Morris Products S.A., Neuchatel (CH)

(21) Appl. No.: 18/245,374

(22) PCT Filed: Sep. 23, 2021
(86) PCT No.: PCT/EP2021/076233

§ 371 Date: Mar. 15, 2023

(30) Foreign Application Priority Data
Sep. 23, 2020 (EP) 20197860.8

(51) Int. Cl. H05B 3/44; A24F 40/46

(52) U.S. Cl. CPC H05B 3/44; A24F 40/46; A24F 40/10

(57) ABSTRACT

A heater assembly for an aerosol-generating system is provided, including: a heating element including a mesh having first and second filaments respectively extending in perpendicular first and second directions, and respectively including first and second materials respectively having first and second electrical conductivities, the first conductivity being greater than the second conductivity, each of the first filaments including a core and an overlying coating including the first material, and the core of each of the first filaments being formed from a material having a lower electrical conductivity than the first material; and at least two electrical terminals to supply electrical power to the heating element, each of the terminals being connected to at least one of the first filaments, the electrical terminals including first and second electrical terminals, and, during use, electrical current is conducted between the first and the second electrical terminals via the second filaments.

The present invention relates to a heating element for an aerosol-generating system. In particular, the present invention relates to a heating element for an aerosol-generating system, the heater element comprising first and second filaments extending in first and second directions. The first filaments comprise a first material and the second filaments comprise a second material, wherein the first material has a greater electrically conductivity than the second material. The present invention also relates to a heater assembly, a cartridge, an aerosol-generating system and a method of forming a mesh.

Handheld electrically operated aerosol-generating devices and systems are known that comprise a device portion comprising a battery and control electronics, a portion for containing or receiving a liquid aerosol-forming substrate and an electrically operated heater for heating the aerosol-forming substrate to generate an aerosol. The heater typically comprises a coil of wire which is wound around an elongate wick which transfers liquid aerosol-forming substrate from the liquid storage compartment to the heater. An electric current can be passed through the coil of wire to heat the heater and thereby generate an aerosol from the aerosol-forming substrate. In other devices the heater may comprise an electrically conductive mesh. A mouthpiece portion is also included on which a user may puff to draw aerosol into their mouth.

Some electrical components of aerosol-generating devices, such as soldered electrical connections, may comprise tin. For example, aerosol-generating devices including a heater comprising an electrically conductive mesh may comprise at least one tin electrode extending across a portion of the mesh to distribute electrical current across the filaments of the mesh. However, when the aerosol-generating devices are used with liquid aerosol-forming substrates comprising one or more acids, corrosion of the tin components of the aerosol-generating device may occur.

It would be desirable to provide a heating element for an aerosol-generating system that mitigates or overcomes these problems with known aerosol-generating devices.

According to the present disclosure, there is provided a heating element for an aerosol-generating system, the heating element comprising a mesh. The mesh may comprise a plurality of first filaments extending in a first direction. The first filaments may comprise a first material having a first electrical conductivity. The mesh may comprise a plurality of second filaments extending in a second direction. The first direction may be perpendicular to the second direction. The second filaments may comprise a second material having a second electrical conductivity. The first electrical conductivity may be greater than the second electrical conductivity.

According to a first aspect of the present disclosure, there is provided a heating element for an aerosol-generating system, the heating element comprising a mesh. The mesh comprises a plurality of first filaments extending in a first direction, wherein the first filaments comprise a first material having a first electrical conductivity. The mesh also comprises a plurality of second filaments extending in a second direction, wherein the first direction is perpendicular to the second direction. The second filaments comprise a second material having a second electrical conductivity. The first electrical conductivity is greater than the second electrical conductivity.

Advantageously, the greater electrical conductivity of the first material may facilitate distribution of electric current from a power supply to the second filaments via the first filaments. Advantageously, facilitating the distribution of electric current to the second filaments may eliminate the need for an electrode on the mesh. For example, an electrical wire or other electrical contact may be electrically connected directly to one or more of the first filaments. Advantageously, this may eliminate the need for a tin electrode that is provided on the mesh heating elements of known aerosol-generating devices.

Advantageously, the lower electrical conductivity of the second material may facilitate resistive heating of the second filaments when an electrical current is conducted through the second filaments.

In embodiments in which the second filaments are formed from a material comprising a positive temperature coefficient, hot spots that may form during operation of the heating element will result in areas of increased electrical resistance in the second filaments that correspond to the hot spots. Advantageously, the greater electrical conductivity of the first material facilitates the distribution of electrical current away from such areas of increased electrical resistance in the second filaments, which may facilitate more uniform heating across the mesh.

Preferably, the first material has an electrical conductivity of between about 8×10⁶ Siemens per metre and about 80×10⁶ Siemens per metre.

Preferably, the second material has an electrical conductivity of between about 0.8×10⁶ Siemens per metre and about 1.7×10⁶ Siemens per metre.

Preferably, the first material comprises at least one of silver, gold, platinum, aluminium, tin, and copper. Preferably, the first material comprises at least one of silver, gold, and platinum. Preferably, the first material comprises silver. Preferably, the first material is silver.

Each of the first filaments may be formed from the first material. Each of the second filaments may be formed from the second material.

Preferably, each of the first filaments comprises a core and a coating overlying the core. Preferably, the coating comprises the first material. Advantageously, providing each of the first filaments with a coating comprising the first material may provide the first filaments with a greater electrical conductivity than the second filaments. Advantageously, the core of each of the first filaments may be formed from a material having a lower electrical conductivity, which may reduce or minimise the cost of each of the first filaments.

The coating of each of the first filaments may have a thickness of at least about 1 micrometre, at least about 2 micrometres, at least about 3 micrometres, or at least about 4 micrometres. The coating of each of the first filaments may have a thickness of less than about 5 micrometres, less than about 4 micrometres, less than about 3 micrometres, or less than about 2 micrometres. Preferably, the coating of each of the first filaments has a thickness of between about 1 micrometre and about 5 micrometres, more preferably between about 2 micrometres and about 5 micrometres, more preferably between about 2 micrometres and about 4 micrometres, more preferably between about 3 micrometres and about 4 micrometres.

The coating may be formed by at least one of a spraying process, a chemical vapour deposition process, and a physical vapour deposition process.

The core of each of the first filaments may comprise a metal alloy. Examples of suitable metal alloys include stainless steel, constantan, nickel-, cobalt-, chromium-, aluminium-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminium based alloys and iron-manganese-aluminium based alloys. Timetal® is a registered trade mark of Titanium Metals Corporation. Preferably, the core of each of the first filaments comprises stainless steel, more preferably 300 series stainless steel such as AISI 304, 316, 304L, 316L.

In a particularly preferred embodiment, each of the first filaments comprises a core comprising AISI 304 stainless steel and a coating comprising silver.

The second material may comprise a metal alloy. Examples of suitable metal alloys include stainless steel, constantan, nickel-, cobalt-, chromium-, aluminium-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminium based alloys and iron-manganese-aluminium based alloys. Timetal® is a registered trade mark of Titanium Metals Corporation. Preferably, the second material comprises stainless steel, more preferably 300 series stainless steel such as AISI 304, 316, 304L, 316L. In a particularly preferred embodiment, the second material comprises AISI 304 stainless steel.

The core of each of the first filaments may comprise a different material than the second material.

The core of each of the first filaments may also comprise the second material. Preferably, the core of each of the first filaments and each of the second filaments comprises stainless steel, more preferably 300 series stainless steel such as AISI 304, 316, 304L, 316L. In a particularly preferred embodiment, the core of each of the first filaments and each of the second filaments comprises AISI 304 stainless steel.

The mesh may be woven or non-woven. Preferably, the mesh is woven.

The first filaments may extend in the weft direction and the second filaments may extend in the warp direction. The first filaments may extend in the warp direction and the second filaments may extend in the weft direction.

The mesh may define interstices between the first filaments and the second filaments and the interstices may have a width of between about 10 micrometres and about 100 micrometres. Preferably, the width of the interstices give rise to capillary action in the interstices, so that in use, liquid aerosol-forming substrate to be vaporised is drawn into the interstices, increasing the contact area between the heating element and the liquid aerosol-forming substrate.

The first filaments and the second filaments may form a mesh density of between about and about 240 filaments per centimetre (+1-10 percent). Preferably, the mesh density is between about 100 and about 140 filaments per centimetres (+1-10 percent). More preferably, the mesh density is approximately 115 filaments per centimetre. The width of the interstices may be between about 20 micrometres and about 300 micrometres, preferably between about 50 micrometres and about 100 micrometres, more preferably approximately 70 micrometres. The percentage of open area of the mesh, which is the ratio of the area of the interstices to the total area of the mesh may be between about 40 percent and about 90 percent, preferably between about 85 percent and about 80 percent, more preferably approximately 82 percent.

The each of the first filaments and the second filaments may have a width or a diameter of between about 10 micrometres and about 100 micrometres, preferably between about 10 micrometres and about 50 micrometres, more preferably between about 12 micrometres and about 25 micrometres, and most preferably approximately 16 micrometres. Each of the first filaments and the second filaments may have a round cross-section or may have a flattened cross-section.

The area of the mesh may be small, for example less than or equal to about 50 square millimetres, preferably less than or equal to about 25 square millimetres, more preferably approximately 15 square millimetres. Preferably, the area of the mesh facilitates incorporation of the heating element into a handheld system. Advantageously, sizing of the mesh with an area of less than or equal to about 50 square millimetres reduces the amount of total power required to heat the mesh while still ensuring sufficient contact of the mesh with a liquid aerosol-forming substrate. The mesh may be square. The mesh may be rectangular. The mesh may have a length of between about 2 millimetres and about 10 millimetres. The mesh may have a width of between about 2 millimetres and about 10 millimetres. Preferably, the mesh has dimensions of approximately 5 millimetres by approximately 3 millimetres.

Preferably, the mesh is substantially flat. Advantageously, a substantially flat mesh may facilitate simple manufacture of the heating element and an aerosol-generating system comprising the heating element. Geometrically, the term “substantially flat” is used to refer to a mesh that is in the form of a substantially two dimensional topological manifold. In some examples, the substantially flat mesh may extend in two dimensions along a surface substantially more than in a third dimension. In some examples, the dimensions of the substantially flat mesh in the two dimensions within the surface may be at least five times larger than in the third dimension, normal to the surface. In some examples, the substantially flat mesh may define two imaginary substantially parallel flat surfaces. In some examples, the substantially flat mesh may be a structure between two imaginary substantially parallel flat surfaces, wherein the distance between these two imaginary surfaces is substantially smaller than the extension within the surfaces. In some examples, only one of the two imaginary substantially parallel surfaces may be flat. In some examples, the substantially flat mesh may be planar. In other examples, the substantially flat mesh may be curved along one or more dimensions, for example forming a dome shape or bridge shape.

According to the present disclosure there is provided a heating element for an aerosol-generating system, the heating element comprising a mesh. The mesh may comprise a plurality of first filaments extending in a first direction. Each of the first filaments may comprise at least one of silver, gold, and platinum. The mesh may comprise a plurality of second filaments extending in a second direction. The first direction may be perpendicular to the second direction. Each of the second filaments may comprise stainless steel.

According to a second aspect of the present disclosure there is provided a heating element for an aerosol-generating system, the heating element comprising a mesh. The mesh comprises a plurality of first filaments extending in a first direction, wherein each of the first filaments comprises at least one of silver, gold, and platinum. The mesh also comprises a plurality of second filaments extending in a second direction, wherein the first direction is perpendicular to the second direction. Each of the second filaments comprises stainless steel.

Each of the first filaments may be formed from at least one of silver, gold, and platinum. Each of the first filaments may be formed from silver.

Preferably, each of the first filaments comprises a core and a coating overlying the core, wherein the coating comprises at least one of silver, gold, and platinum. Preferably, the coating comprises silver.

Preferably, the core of each of the first filaments comprises stainless steel, more preferably 300 series stainless steel such as AISI 304, 316, 304L, 316L. In a particularly preferred embodiment, each of the first filaments comprises a core comprising AISI 304 stainless steel.

Preferably, each of the second filaments comprises 300 series stainless steel such as AISI 304, 316, 304L, 316L. In a particularly preferred embodiment, each of the second filaments comprises AISI 304 stainless steel.

The heating element may comprise any of the optional or preferred features described with respect to the first aspect of the present disclosure.

According to a third aspect of the present disclosure, there is provided a heater assembly for an aerosol-generating system. The heater assembly comprises a heating element according to the first aspect of the present disclosure or the second aspect of the present disclosure, in accordance with any of the embodiments described herein. The heater assembly also comprises at least two electrical terminals for supplying electrical power to the heating element, wherein each of the electrical terminals is electrically connected to at least one of the first filaments.

Preferably, each of the electrical terminals is directly connected to at least one of the first filaments. Advantageously, directly connecting the electrical terminals to at least one of the first filaments may reduce the number of components required to manufacture the heater assembly. For example, directly connecting the electrical terminals to at least one of the first filaments may eliminate the need to provide the heating element with one or more electrical contact pads, which would typically formed from tin in known aerosol-generating devices.

Preferably, each of the electrical terminals is directly electrically connected to at least one of the first filaments by mechanically biasing each of the electrical terminals against a portion of the mesh. Each of the electrical terminals may be a spring terminal.

Each of the electrical terminals may comprise brass. Preferably, each of the electrical terminals comprises a substrate material and a coating overlying the substrate material, wherein the coating comprises the first material. Advantageously, providing each of the electrical terminals with a coating comprising the same material as the first material of the first filaments facilitates an improved electrical connection between each electrical terminal and the first filaments in contact with the electrical terminal. Advantageously, providing each of the electrical terminals with a coating comprising the same material as the first material of the first filaments may reduce or prevent galvanic corrosion. The substrate material may comprise brass. The coating may comprise at least one of silver, gold, platinum, aluminium, tin, and copper. Preferably, the coating comprises at least one of silver, gold, and platinum. Preferably, the coating comprises silver. Preferably, the coating is silver.

The heater assembly may further comprise a heater assembly housing, wherein the heating element and the at least two electrical terminals are mounted on the heater assembly housing. The heater assembly housing may comprise a first housing portion on which the heating element is mounted and a second housing portion on which the at least two electrical terminals are mounted. Preferably, the first housing portion is arranged to connect to the second housing portion. Preferably, the first housing portion is arranged to connect to the second housing portion by an interference fit. Preferably, the at least two electrical terminals are mechanically biased against the mesh when the first housing portion is connected to the second housing portion.

The heater assembly housing may comprise any suitable material or combination of materials. Preferably, the heater assembly housing is formed from a plastic or thermoplastic that is suitable for food or pharmaceutical applications. For example, the heater assembly housing may comprise at least one of polypropylene, polyetheretherketone (PEEK) and polyethylene. The material is preferably light and non-brittle.

The heater assembly may further comprise a transport material for conveying a liquid aerosol-forming substrate to the heating element. Preferably, the transport material comprises a first end in contact with the mesh of the heating element. The transport material may comprise a capillary material. The transport material may comprise a capillary wick. The transport material may comprise a ceramic. The ceramic may comprise at least one of aluminium oxide, zirconium oxide and hydroxyapatite.

In embodiments in which the heater assembly comprises a heater assembly housing, at least a portion of the transport material may be received within the heater assembly housing. The transport material may be secured within the heater assembly housing by an interference fit.

The transport material may be formed by directly depositing a material on the mesh of the heating element. The transport material may be formed by directly depositing a ceramic on the mesh of the heating element. The ceramic may comprise at least one of aluminium oxide, zirconium oxide and hydroxyapatite.

According to a fourth aspect of the present disclosure there is provided a cartridge for an aerosol-generating system, the cartridge comprising a heater assembly according to the third aspect of the present disclosure, in accordance with any of the embodiments described herein. The cartridge also comprises a liquid storage compartment for holding a liquid aerosol-forming substrate.

As used herein, the term “aerosol” refers to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosol-forming substrate” refers to a substrate capable of releasing volatile compounds that can form an aerosol. The volatile compounds may be released by heating or combusting the aerosol-forming substrate.

In embodiments in which the heater assembly comprises a heater assembly housing, the heater assembly housing may define at least part of the liquid storage compartment.

The liquid storage compartment may comprise first and second storage portions in communication with one another. A first storage portion of the liquid storage compartment may be on an opposite side of the heater assembly to the second storage portion of the liquid storage compartment. Liquid aerosol-forming substrate may be held in both the first and second storage portions of the liquid storage compartment.

Advantageously, the first storage portion of the storage compartment is larger than the second storage portion of the liquid storage compartment. The cartridge may be configured to allow a user to draw or suck on the cartridge to inhale aerosol generated in the cartridge. In use a mouth end opening of the cartridge is typically positioned above the heater assembly, with the first storage portion of the storage compartment positioned between the mouth end opening and the heater assembly. The first storage portion of the liquid storage compartment being larger than the second storage portion of the liquid storage compartment ensures that liquid is delivered from the first storage portion of the liquid storage compartment to the second storage portion of the liquid storage compartment under the influence of gravity.

The cartridge may have a mouth end through which generated aerosol can be drawn by a user and a connection end configured to connect to an aerosol-generating device. Preferably, a first side of the heating element faces the mouth end and a second side of the heating element faces the connection end.

In embodiments in which the heater assembly comprises a transport material, preferably the transport material is in fluid communication with the liquid storage compartment. Preferably, the transport material is in fluid communication with the second storage portion of the liquid storage compartment. Preferably, a second end of the transport material is positioned within the second storage portion of the liquid storage compartment.

The cartridge may define an enclosed airflow passage from an air inlet past the first side of the heater assembly to a mouth end opening of the cartridge. The enclosed airflow passage may pass through the first storage portion or the second storage portion of the liquid storage compartment. In one embodiment the airflow passage extends between the first storage portion and the second storage portion of the liquid storage compartment. Additionally, the airflow passage may extend through the first storage portion of the liquid storage compartment. At least part of the first storage portion of the liquid storage compartment may have an annular cross section, wherein at least part of the airflow passage extends from the air inlet past the heater assembly to the mouth end opening through the first storage portion of the liquid storage compartment. At least part of the airflow passage may extend from the heater assembly to the mouth end opening adjacent to the first storage portion of the liquid storage compartment.

The cartridge may contain a retention material for holding a liquid aerosol-forming substrate. The retention material may be in the first storage portion of the liquid storage compartment, the second storage portion of the liquid storage compartment, or both the first storage portion and the second storage portion of the liquid storage compartment. The retention material may be a foam, a sponge, or a collection of fibres. The retention material may be formed from a polymer or a co-polymer. The retention material may be a spun polymer. The liquid aerosol-forming substrate may be released into the retention material during use. For example, the liquid aerosol-forming substrate may be provided in a capsule.

The cartridge advantageously contains a liquid aerosol-forming substrate within the liquid storage compartment. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5 percent and about 10 percent, for example about 2 percent.

The cartridge may comprise a housing. The housing may be formed form a mouldable plastics material, such as polypropylene (PP) or polyethylene terephthalate (PET). The housing may form a part or all of a wall of one or both portions of the liquid storage compartment. The housing and liquid storage compartment may be integrally formed. Alternatively the liquid storage compartment may be formed separately from the housing and assembled to the housing.

According to a fifth aspect of the present disclosure there is provided an aerosol-generating system comprising a cartridge according to the fourth aspect of the present disclosure, in accordance with any of the embodiments described herein. The aerosol-generating system also comprises an aerosol-generating device arranged to be removably coupled to the cartridge. The aerosol-generating device comprises a power supply for supplying electrical power to the heating element.

The aerosol-generating device may comprise control circuitry configured to control a supply of electrical power from the power supply to the heating element.

The control circuitry may comprise a microprocessor. The microprocessor may be a programmable microprocessor, a microcontroller, or an application specific integrated chip (ASIC) or other electronic circuitry capable of providing control. The control circuitry may comprise further electronic components. For example, in some embodiments, the control circuitry may comprise any of: sensors, switches, display elements. Power may be supplied to the heating element continuously following activation of the aerosol-generating device or may be supplied intermittently, such as on a puff-by-puff basis. The power may be supplied to the heating element in the form of pulses of electrical current, for example, by means of pulse width modulation (PWM).

The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences; for example, the power supply may have sufficient capacity to allow for the continuous generation of aerosol for a period of about six minutes, corresponding to the typical time taken to smoke a conventional cigarette, or for a period that is a multiple of six minutes. In another example, the power supply may have sufficient capacity to allow for a predetermined number of puffs or discrete activations of the heating element.

The aerosol-generating device may comprise a device housing. The device housing may be elongate. The device housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating system may be a handheld aerosol-generating system. The aerosol-generating system may be a handheld aerosol-generating system configured to allow a user to puff on a mouthpiece to draw an aerosol through a mouth end opening. The aerosol-generating system may have a size comparable to a conventional cigar or cigarette. The aerosol-generating system may have a total length of between about 30 millimetres and about 150 millimetres. The aerosol-generating system may have an external diameter of between about 5 millimetres and about 30 millimetres.

According to the present disclosure there is provided a method of forming a mesh for use as a heating element for an aerosol-generating system. The method may comprise providing a plurality of first filaments. The plurality of first filaments may comprise a first material having a first electrical conductivity. The method may comprise providing a plurality of second filaments. The plurality of second filaments may comprise a second material having a second electrical conductivity. The first electrical conductivity may be greater than the second electrical conductivity. The method may comprise forming a mesh comprising the plurality of first filaments extending in a first direction and the plurality of second filaments extending in a second direction. The first direction may be perpendicular to the second direction.

According to a sixth aspect of the present disclosure there is provided a method of forming a mesh for use as a heating element for an aerosol-generating system. The method comprises providing a plurality of first filaments comprising a first material having a first electrical conductivity. The method also comprises providing a plurality of second filaments comprising a second material having a second electrical conductivity, wherein the first electrical conductivity is greater than the second electrical conductivity. The method also comprises forming a mesh comprising the plurality of first filaments extending in a first direction and the plurality of second filaments extending in a second direction, wherein the first direction is perpendicular to the second direction.

The mesh formed by the method according to the sixth aspect of the present disclosure may be a mesh according to the first aspect of the present disclosure, in accordance with any of the embodiments described herein. The mesh formed by the method according to sixth aspect of the present disclosure may comprise any of the optional or preferred features described with respect to the first aspect of the present disclosure.

Preferably, the method further comprises heat treating the mesh to bond the plurality of first filaments to the plurality of second filaments. Advantageously, bonding the plurality of first filaments to the plurality of second filaments reduces the electrical resistance at the contact points between the plurality of first filaments and the plurality of second filaments.

The step of forming a mesh may comprise weaving the plurality of first filaments with the plurality of second filaments to form a woven mesh. The first filaments may extend in the weft direction and the second filaments may extend in the warp direction. The first filaments may extend in the warp direction and the second filaments may extend in the weft direction.

According to the present disclosure there is provided a method of forming a mesh for use as a heating element for an aerosol-generating system. The method may comprise providing a plurality of first filaments. Each of the first filaments may comprise at least one of silver, gold, and platinum. The method may comprise providing a plurality of second filaments. Each of the second filaments may comprise stainless steel. The method may comprise forming a mesh comprising the plurality of first filaments extending in a first direction and the plurality of second filaments extending in a second direction. The first direction may be perpendicular to the second direction.

According to a seventh aspect of the present disclosure there is provided a method of forming a mesh for use as a heating element for an aerosol-generating system. The method comprises providing a plurality of first filaments, wherein each of the first filaments comprises at least one of silver, gold, and platinum. The method also comprises providing a plurality of second filaments, wherein each of the second filaments comprises stainless steel. The method also comprises forming a mesh comprising the plurality of first filaments extending in a first direction and the plurality of second filaments extending in a second direction, wherein the first direction is perpendicular to the second direction.

Each of the first filaments may be formed from at least one of silver, gold, and platinum. Each of the first filaments may be formed from silver.

Preferably, each of the first filaments comprises a core and a coating overlying the core, wherein the coating comprises at least one of silver, gold, and platinum. Preferably, the coating comprises silver.

Preferably, the core of each of the first filaments comprises stainless steel, more preferably 300 series stainless steel such as AISI 304, 316, 304L, 316L. In a particularly preferred embodiment, each of the first filaments comprises a core comprising AISI 304 stainless steel.

Preferably, each of the second filaments comprises 300 series stainless steel such as AISI 304, 316, 304L, 316L. In a particularly preferred embodiment, each of the second filaments comprises AISI 304 stainless steel.

The mesh formed by the method according to the seventh aspect of the present disclosure may be a mesh according to the first aspect of the present disclosure, in accordance with any of the embodiments described herein. The mesh formed by the method according to seventh aspect of the present disclosure may comprise any of the optional or preferred features described with respect to the first aspect of the present disclosure.

The mesh formed by the method according to the seventh aspect of the present disclosure may be a mesh according to the second aspect of the present disclosure, in accordance with any of the embodiments described herein. The mesh formed by the method according to seventh aspect of the present disclosure may comprise any of the optional or preferred features described with respect to the second aspect of the present disclosure.

Preferably, the method further comprises heat treating the mesh to bond the plurality of first filaments to the plurality of second filaments. Advantageously, bonding the plurality of first filaments to the plurality of second filaments reduces the electrical resistance at the contact points between the plurality of first filaments and the plurality of second filaments.

The step of forming a mesh may comprise weaving the plurality of first filaments with the plurality of second filaments to form a woven mesh. The first filaments may extend in the weft direction and the second filaments may extend in the warp direction. The first filaments may extend in the warp direction and the second filaments may extend in the weft direction.

The invention is defined in the claims. However, below there is provided a non-exhaustive list of non-limiting examples. Any one or more of the features of these examples may be combined with any one or more features of another example, embodiment, or aspect described herein.

Example Ex1: A heating element for an aerosol-generating system, the heating element comprising a mesh, the mesh comprising:
a plurality of first filaments extending in a first direction, wherein the first filaments comprise a first material having a first electrical conductivity;
a plurality of second filaments extending in a second direction, wherein the first direction is perpendicular to the second direction, and wherein the second filaments comprise a second material having a second electrical conductivity; and
wherein the first electrical conductivity is greater than the second electrical conductivity.

Example Ex2: A heating element according to Example Ex1, wherein each of the first filaments comprises a core and a coating overlying the core.

Example Ex3: A heating element according to Example Ex2, wherein the coating comprises the first material.

Example Ex4: A heating element according to Example Ex2 or Ex3, wherein the core comprises stainless steel.

Example Ex5: A heating element according to any of Examples Ex2 to Ex4, wherein the coating has a thickness of between 1 micrometre and 5 micrometres.

Example Ex6: A heating element according to any of Examples Ex2 to Ex5, wherein the core of each of the first filaments comprises the same material as each of the second filaments.

Example Ex7: A heating element according to any preceding Example, wherein the coating comprises at least one of silver, gold and platinum.

Example Ex8: A heating element according to any preceding Example, wherein each of the second filaments comprises stainless steel.

Example Ex9: A heating element according to any preceding Example, wherein the mesh is a woven mesh.

Example Ex10: A heater assembly for an aerosol-generating system, the heater assembly comprising:
a heating element according to any preceding Example; and
at least two electrical terminals for supplying electrical power to the heating element, wherein each of the electrical terminals is connected to at least one of the first filaments.

Example Ex11: A heater assembly according to Example Ex10, further comprising a transport material for conveying a liquid aerosol-forming substrate to the heating element.

Example Ex12: A cartridge for an aerosol-generating system, the cartridge comprising:
a heater assembly according to Example Ex10 or Ex11; and
a liquid storage compartment for holding a liquid aerosol-forming substrate.

Example Ex13: An aerosol-generating system comprising:
a cartridge according to Example Ex12; and
an aerosol-generating device arranged to be removably coupled to the cartridge, the aerosol-generating device comprising a power supply for supplying electrical power to the heating element.

Example Ex14: A method of forming a mesh for use as a heating element for an aerosol-generating system, the method comprising:
providing a plurality of first filaments comprising a first material having a first electrical conductivity;
providing a plurality of second filaments comprising a second material having a second electrical conductivity, wherein the first electrical conductivity is greater than the second electrical conductivity; and
forming a mesh comprising the plurality of first filaments extending in a first direction and the plurality of second filaments extending in a second direction, wherein the first direction is perpendicular to the second direction.

Example Ex15: A method according to Example Ex14, further comprising heat treating the mesh to bond the plurality of first filaments to the plurality of second filaments.

Example Ex16: A method according to Example Ex14 or Ex15, wherein each of the first filaments comprises a core and a coating overlying the core.

Example Ex17: A method according to Example Ex16, wherein the coating comprises the first material.

Example Ex18: A method according to Example Ex16 or Ex17, wherein the core comprises stainless steel.

Example Ex19: A method according to any of Examples Ex16 to Ex18, wherein the coating has a thickness of between 1 micrometre and 5 micrometres.

Example Ex20: A method according to any of Examples Ex16 to Ex19, wherein the core of each of the first filaments comprises the same material as each of the second filaments.

Example Ex21: A method according to any of Examples Ex16 to Ex20, wherein the coating comprises at least one of silver, gold and platinum.

Example Ex22: A method according to any of Examples Ex14 to Ex21, wherein the second material comprises stainless steel.

Example Ex23: A method according to any of Example Ex14 to Ex22, wherein forming a mesh comprising weaving the plurality of first filaments with the plurality of second filaments to form a woven mesh.

Example Ex24: A heating element for an aerosol-generating system, the heating element comprising a mesh, the mesh comprising:
a plurality of first filaments extending in a first direction, wherein each of the first filaments comprises at least one of silver, gold, and platinum; and
a plurality of second filaments extending in a second direction, wherein the first direction is perpendicular to the second direction, and wherein each of the second filaments comprises stainless steel.

Example Ex25: A heating element according to Example Ex24, wherein each of the first filaments is formed from at least one of silver, gold, and platinum.

Example Ex26: A heating element according to Example Ex24, wherein each of the first filaments is formed from silver.

Example Ex27: A heating element according to Example Ex24, wherein each of the first filaments comprises a core and a coating overlying the core.

Example Ex28: A heating element according to Example Ex27, wherein the core comprises stainless steel.

Example Ex29: A heating element according to Example Ex27 or Ex28, wherein the coating comprises at least one of silver, gold and platinum.

Example Ex30: A heating element according to Example Ex29, wherein the coating comprises silver.

Example Ex31: A heating element according to Example Ex27 or Ex28, wherein the coating is formed from at least one of silver, gold and platinum.

Example Ex32: A heating element according to Example Ex31, wherein the coating is formed from silver.

Example Ex33: A heating element according to any of Examples Ex27 to Ex32, wherein the coating has a thickness of between 1 micrometre and 5 micrometres.

Example Ex34: A heating element according to any of Examples Ex24 to Ex33, wherein the mesh is a woven mesh.

Example Ex35: A heater assembly for an aerosol-generating system, the heater assembly comprising:
a heating element according to any of Examples Ex24 to Ex34; and
at least two electrical terminals for supplying electrical power to the heating element, wherein each of the electrical terminals is connected to at least one of the first filaments.

Example Ex36: A heater assembly according to Example Ex35, further comprising a transport material for conveying a liquid aerosol-forming substrate to the heating element.

Example Ex37: A cartridge for an aerosol-generating system, the cartridge comprising:
a heater assembly according to Example Ex35 or Ex36; and
a liquid storage compartment for holding a liquid aerosol-forming substrate.

Example Ex38: An aerosol-generating system comprising:
a cartridge according to Example Ex37; and
an aerosol-generating device arranged to be removably coupled to the cartridge, the aerosol-generating device comprising a power supply for supplying electrical power to the heating element.

Example Ex39: A method of forming a mesh for use as a heating element for an aerosol-generating system, the method comprising:
providing a plurality of first filaments, wherein each of the first filaments comprises at least one of silver, gold, and platinum;
providing a plurality of second filaments, wherein each of the second filaments comprises stainless steel; and
forming a mesh comprising the plurality of first filaments extending in a first direction and the plurality of second filaments extending in a second direction, wherein the first direction is perpendicular to the second direction.

Example Ex40: A method according to Example Ex39, further comprising heat treating the mesh to bond the plurality of first filaments to the plurality of second filaments.

Example Ex41: A method according to Example Ex39 or Ex40, wherein each of the first filaments is formed from at least one of silver, gold, and platinum.

Example Ex42: A method according to Example Ex41, wherein each of the first filaments is formed from silver.

Example Ex43: A method according to Example Ex39 or Ex40, wherein each of the first filaments comprises a core and a coating overlying the core.

Example Ex44: A method according to Example Ex43, wherein the core comprises stainless steel.

Example Ex45: A method according to Example Ex43 or Ex44, wherein the coating comprises at least one of silver, gold and platinum.

Example Ex46: A method according to Example Ex45, wherein the coating comprises silver.

Example Ex47: A method according to Example Ex43 or Ex44, wherein the coating is formed from at least one of silver, gold and platinum.

Example Ex48: A method according to Example Ex47, wherein the coating is formed from silver.

Example Ex49: A method according to any of Examples Ex39 to Ex48, wherein the coating has a thickness of between 1 micrometre and 5 micrometres.

Example Ex50: A method according to any of Example Ex39 to Ex49, wherein forming a mesh comprising weaving the plurality of first filaments with the plurality of second filaments to form a woven mesh.

Examples will now be further described with reference to the figures in which:

FIG. 1 is a schematic perspective view of a heater assembly in accordance with an example of the present disclosure;

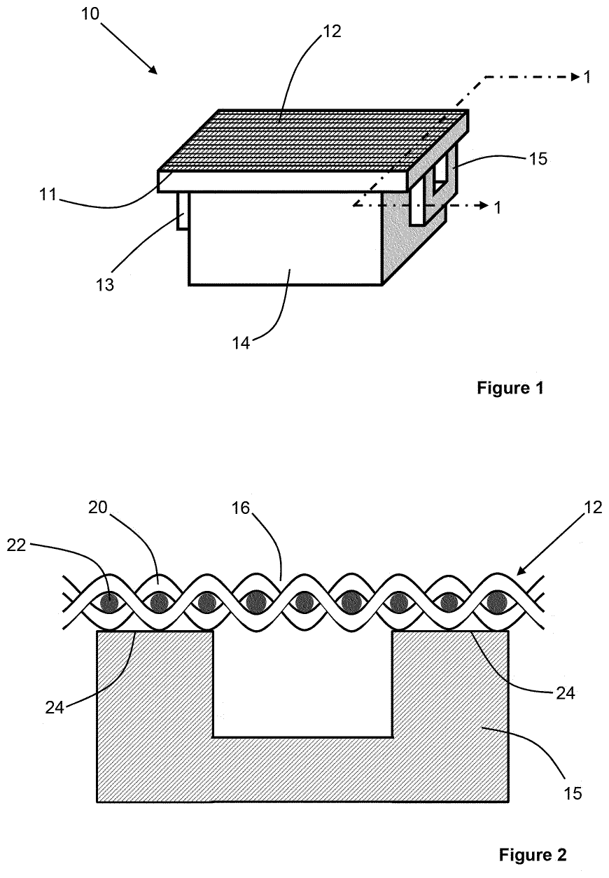

FIG. 2 is schematic side cross-sectional view of the heater assembly of FIG. 1 taken along the line 1-1 in FIG. 1;

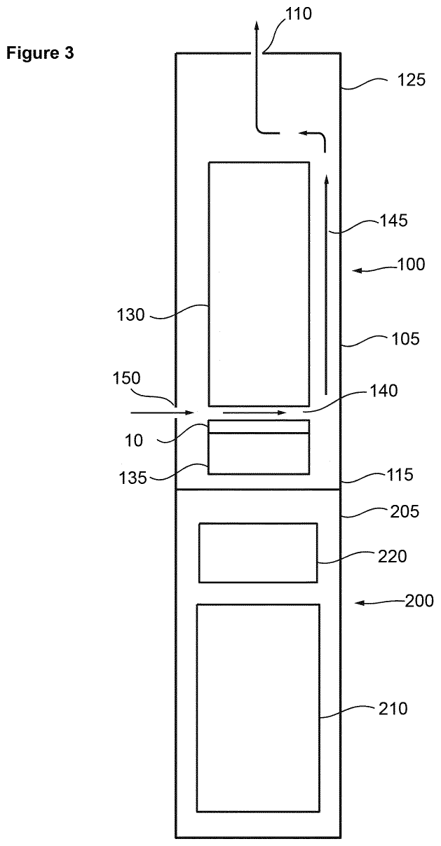

FIG. 3 is a schematic side cross-sectional view of an example aerosol-generating system comprising a cartridge and an aerosol-generating device; and

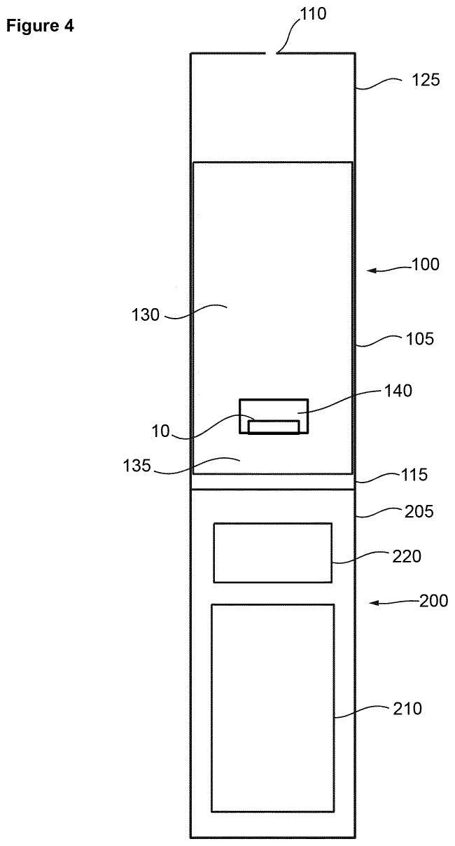

FIG. 4 a schematic side cross-sectional view of the aerosol-generating system of FIG. 3 rotated through 90 degrees about the longitudinal axis of the aerosol-generating system.

Referring to FIG. 1, there is shown a heater assembly 10 comprising a heating element 11, a ceramic transport material 14, a first electrical terminal 13 and a second electrical terminal 15. FIG. 2 shows a cross-sectional view of the heater assembly 10 along line 1-1 of FIG. 1.

The heating element 11 comprises an electrically conductive mesh 12. The mesh 12 is woven and comprises a plurality of first filaments 20 extending in a first direction and a plurality of second filaments 22 extending in a second direction perpendicular to the first direction. Each of the second filaments 22 is formed from stainless steel. Each of the first filaments 20 is formed from a core of stainless steel and a coating overlying the core, the coating being formed from silver. The silver coating of each of the first filaments 20 has a higher electrical conductivity than the stainless steel forming each of the second filaments 22.

The first and second electrical terminals 13, 15 for supplying electrical current to the mesh 12 are formed of brass and arranged at opposing sides of the mesh 12. Each of the first and second electrical terminals 13, 15 comprise two contact portions 24, wherein each of the contact portions 24 is biased against several of the first filaments 20. The higher conductivity of the silver coating of the first filaments 20 facilitates distribution of electrical current from the first and second electrical terminals 13, 15 to the plurality of second filaments 22 via the first filaments 20. During use, electrical current is conducted between the first and second electrical terminals 13, 15 via the plurality of second filaments 22. The lower electrical conductivity of the second filaments 22 facilitates resistive heating of the second filaments 22 when electrical current flows through the second filaments 22.

The ceramic transport material 14 is in direct contact with the mesh 12 and is arranged to convey a liquid aerosol-forming substrate to the mesh 12. A plurality of interstices 16 are defined between the first and second filaments 20, 22 of the mesh 12. During heating, vaporised aerosol-forming substrate is released from the heater assembly 10 via the interstices 16 to generate an aerosol.

FIG. 3 is a schematic cross-sectional view of an example aerosol-generating system. FIG. 4 shows the same cross-sectional view with the aerosol-generating system rotated through 90 degrees about its longitudinal axis.

The aerosol-generating system comprises two main components, a cartridge 100 and an aerosol-generating device 200. A connection end 115 of the cartridge 100 is removably connected to a corresponding connection end 205 of the aerosol-generating device 200. The connection end 115 of the cartridge 100 and connection end 205 of the aerosol-generating device 200 each have electrical contacts or connections (not shown) which are arranged to cooperate to provide an electrical connection between the cartridge 100 and the aerosol-generating device 200. The aerosol-generating device 200 contains a power supply 210 in the form of a battery, which in this example is a rechargeable lithium ion battery, and control circuitry 220. The aerosol-generating system is portable and has a size comparable to a conventional cigar or cigarette. A mouthpiece 125 is arranged at the end of the cartridge 100 opposite the connection end 115.

The cartridge 100 comprises a cartridge housing 105 containing the heater assembly 10 of FIGS. 1 and 2 and a liquid storage compartment having a first storage portion 130 and a second storage portion 135. A liquid aerosol-forming substrate is held in the liquid storage compartment. As shown in FIG. 4, the first storage portion 130 of the liquid storage compartment is connected to the second storage portion 135 of the liquid storage compartment by an annular part of the first storage portion 130. Therefore, liquid aerosol-forming substrate in the first storage portion 130 can pass to the second storage portion 135. The heater assembly 10 receives liquid from the second storage portion 135 of the liquid storage compartment. At least a portion of the ceramic transport material 14 of the heater assembly 10 extends into the second storage portion 135 of the liquid storage compartment to contact the liquid aerosol-forming substrate therein.

An air flow passage 140, 145 extends through the cartridge 100 from an air inlet 150 formed in a side of the cartridge housing 105, past the mesh 12 of the heater assembly 10, and from the heater assembly 10 to a mouthpiece opening 110 formed in the cartridge housing 105 at an end of the cartridge 100 opposite to the connection end 115.

The components of the cartridge 100 are arranged so that the first storage portion 130 of the liquid storage compartment is between the heater assembly 10 and the mouthpiece opening 110, and the second storage portion 135 of the liquid storage compartment is positioned on an opposite side of the heater assembly 10 to the mouthpiece opening 110. In other words, the heater assembly 10 lies between the first and second portions 130, 135 of the liquid storage compartment and receives liquid from the second storage portion 135. The first storage portion 130 of the liquid storage compartment is closer to the mouthpiece opening 110 than the second storage portion 135 of the liquid storage compartment. The air flow passage 140, 145 extends past the mesh 12 of the heater assembly 10 and between the first 130 and second 135 portions of the liquid storage compartment.

The aerosol-generating system is configured so that a user can puff or draw on the mouthpiece 125 of the cartridge to draw aerosol into their mouth through the mouthpiece opening 110. In operation, when a user puffs on the mouthpiece 125, air is drawn through the airflow passage 140, 145 from the air inlet 150, past the heater assembly 10, to the mouthpiece opening 110. The control circuitry 220 controls the supply of electrical power from the power supply 210 to the cartridge 100 when the system is activated. This in turn controls the amount and properties of the vapour produced by the heater assembly 10. The control circuitry 220 may include an airflow sensor (not shown) and the control circuitry 220 may supply electrical power to the heater assembly 10 when user puffs are detected by the airflow sensor. This type of control arrangement is well established in aerosol-generating systems such as inhalers and e-cigarettes. When a user puffs on the mouthpiece opening 110 of the cartridge 100, the heater assembly 10 is activated and generates a vapour that is entrained in the air flow passing through the air flow passage 140. The vapour cools within the airflow in passage 145 to form an aerosol, which is then drawn into the user's mouth through the mouthpiece opening 110.

In operation, the mouthpiece opening 110 is typically the highest point of the system. The construction of the cartridge 100, and in particular the arrangement of the heater assembly 10 between the first and second storage portions 130, 135 of the liquid storage compartment, is advantageous because it exploits gravity to ensure that the liquid aerosol-forming substrate is delivered to the heater assembly 10 even when the liquid storage compartment is becoming empty, but prevents an oversupply of liquid to the heater assembly 10 which might lead to leakage of liquid into the air flow passage 140.

1.-18. (canceled)

19. A heater assembly for an aerosol-generating system, the heater assembly comprising:
a heating element comprising a mesh, the mesh comprising:
a plurality of first filaments extending in a first direction, wherein the first filaments comprise a first material having a first electrical conductivity,
a plurality of second filaments extending in a second direction, wherein the first direction is perpendicular to the second direction, and wherein the second filaments comprise a second material having a second electrical conductivity,
wherein the first electrical conductivity is greater than the second electrical conductivity,
wherein each of the first filaments comprises a core and a coating overlying the core,
wherein the coating comprises the first material, and
wherein the core of each of the first filaments is formed from a material having a lower electrical conductivity than the first material; and
at least two electrical terminals configured to supply electrical power to the heating element,
wherein each of the electrical terminals is connected to at least one of the first filaments,
wherein the at least two electrical terminals comprise a first electrical terminal and a second electrical terminal, and
wherein, during use, electrical current is conducted between the first electrical terminal and the second electrical terminal via the plurality of second filaments.

20. The heater assembly according to claim 19, wherein the core comprises stainless steel.

21. The heater assembly according to claim 19, wherein the coating has a thickness of between 1 micrometer and 5 micrometers.

22. The heater assembly according to claim 19, wherein the core of each of the first filaments comprises a same material as each of the second filaments.

23. The heater assembly according to claim 19, wherein the first material comprises at least one of silver, gold, and platinum.

24. The heater assembly according to claim 19, wherein the second material comprises stainless steel.

25. The heater assembly according to claim 19, wherein the mesh is a woven mesh.

26. The heater assembly according to claim 19, further comprising a transport material configured to convey a liquid aerosol-forming substrate to the heating element.

27. A cartridge for an aerosol-generating system, the cartridge comprising:
a heater assembly according to claim 19; and
a liquid storage compartment configured to hold a liquid aerosol-forming substrate.

28. An aerosol-generating system, comprising:
a cartridge according to claim 27; and
an aerosol-generating device arranged to be removably coupled to the cartridge, the aerosol-generating device comprising a power supply configured to supply electrical power to the heating element.

29. A method of forming a heater assembly for an aerosol-generating system, the method comprising:
forming a mesh for use as a heating element, the forming the mesh comprising:
providing a plurality of first filaments comprising a first material having a first electrical conductivity, wherein each of the first filaments comprises a core and a coating overlying the core, wherein the coating comprises the first material, and wherein the core of each of the first filaments is formed from a material having a lower electrical conductivity than the first material,
providing a plurality of second filaments comprising a second material having a second electrical conductivity, wherein the first electrical conductivity is greater than the second electrical conductivity, and
forming a mesh comprising the plurality of first filaments extending in a first direction and the plurality of second filaments extending in a second direction, wherein the first direction is perpendicular to the second direction; and
providing at least two electrical terminals for supplying electrical power to the mesh heating element, wherein the providing the at least two electrical terminals comprises:
providing a first electrical terminal and a second electrical terminal, and
connecting each of the electrical terminals to at least one of the first filaments of the mesh so that, during use of the heater assembly, electrical current is conducted between the first electrical terminal and the second electrical terminal via the plurality of second filaments.

30. The method according to claim 29, further comprising heat treating the mesh to bond the plurality of first filaments to the plurality of second filaments.

31. The method according to claim 29, wherein the core comprises stainless steel.

32. The method according to claim 29, wherein the coating has a thickness of between 1 micrometer and 5 micrometers.

33. The method according to claim 29, wherein the core of each of the first filaments comprises a same material as each of the second filaments.

34. The method according to claim 29, wherein the first material comprises at least one of silver, gold, and platinum.

35. The method according to claim 29, wherein the second material comprises stainless steel.

36. The method according to claim 29, wherein the forming the mesh further comprises weaving the plurality of first filaments with the plurality of second filaments to form a woven mesh.
